(19) United States
(12) Patent Application Publication
(10) Pub. No.: US 2017/0286875 A1
(43) Pub. Date: Oct. 5, 2017

(54) SEAT INFORMATION PROVIDING METHOD AND DEVICE

(71) Applicant: Alibaba Group Holding Limited, Grand Cayman (KY)

(72) Inventor: Yunguang Luo, Zhejiang (CN)

(21) Appl. No.: 15/629,615

(22) Filed: Jun. 21, 2017

Related U.S. Application Data
(63) Continuation of application No. PCT/CN2015/097645, filed on Dec. 16, 2015.

(30) Foreign Application Priority Data
Dec. 26, 2014 (CN) 201410832165.5

(51) Int. Cl. G06Q 10/02

(52) U.S. Cl. CPC G06Q 10/02

(57) ABSTRACT

A method and an apparatus for providing seat information are disclosed. The method includes: receiving, by a server, a request uploaded by a client terminal for booking a seat in a current site; querying a preset seat information database to determine preference level information of seats in the current site, preference level information of seats in target sites being stored in the seat information database; determining seat information to be recommended from remaining vacant seats of the current site according to the preference level information of the seats; and returning the seat information to be recommended to the client terminal. By using the method, an operation time for seat selection can be reduced for a user, thus improving the efficiency of booking a seat through a client terminal.

### CROSS REFERENCE TO RELATED PATENT APPLICATIONS

This application claims priority to and is a continuation of PCT Patent Application No. PCT/CN2015/097645, filed on 16 Dec. 2015, and is related to and claims priority to Chinese Patent Application No. 201410832165.5, filed on 26 Dec. 2014, entitled “Seat Information Providing Method and Device,” which is hereby incorporated by reference in its entirety.

### TECHNICAL FIELD

The present disclosure relates to the technical field of information application services, and in particular, methods and apparatuses for providing seat information.

### BACKGROUND

As the standard of living gradually increases, various types of recreational activities have become an indispensable part of the daily lives of people. Furthermore, with the continuous improvement in the manufacturing technologies and the decrease in manufacturing costs for electronic terminal products, various types of electronic terminal products have become unprecedentedly popular. The terminal electronic products have experienced many diversified trends in development, and played an important role in many aspects of the daily lives of people. People often encounter different types of activities for which seats need to be selected in advance in their daily lives, such as going to a cinema to watch a film, going to a theatre to enjoy an opera or a drama, watching various live shows or games, and so on. With the assistance of some electronic products of terminal devices, users can usually select seats and book tickets through applications installed in the terminal devices when such recreational activities are performed.

When a user reserves a seat with the assistance of an application in a terminal device, the user usually needs to go through a procedure as follows: entering a ticket booking application in the terminal device first, selecting a session of a show to be watched, selecting a venue (e.g., selecting a cinema hall number), selecting a seat in the venue, and finally performing operations such as making a payment and an exchange. In a traditional handling process, a user may not know an optimal viewing position in an unfamiliar site in advance, and can only select a seat based on previous experience, thus usually missing the optimal viewing position in the venue. In addition, if a satisfactory seat cannot be found in the current venue, the user has to return to a previous procedure to select a session, a venue, etc., again, which causes a waste of time of the user.

In short, a problem that needs to be solved by one skilled in the art is to provide a method for providing seat information to enable a more efficient way of providing seat information in a venue to a user, thus facilitating the user to select a seat and reducing an operation time of the user.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides a method and an apparatus for providing seat information, which can provide seat information in a target site to a user in a more efficient way, thus reducing an operation time for the user to select a seat, and improving the efficiency of seat booking.

The present disclosure provides solutions as follows.

In implementations, a method for creating a seat information database may include collecting preferentially selected seat information in a target site based on historical seat selection records in the target site; determining preference level information of seats in the target site according to the preferentially selected seat information; and storing seat information of the seats and the preference level information corresponding to the seats in the target site as entries in a seat information database.

In implementations, a method for providing seat information may include receiving a request for booking a seat in a current site that is uploaded by a client terminal at a server; querying a preset seat information database, to determine preference level information of seats in the current site, the seat information database storing respective preference level information of seats in target sites; determining information of seat(s) to be recommended from among vacant seats that are remained in the current site according to the preference level information of the seats; and returning the information of the seat(s) to be recommended to the client terminal.

In implementations, a method for providing seat information may include sending a request for booking a seat in a current site from a client terminal to a server, to cause the server to query a preset seat information database for determining information of preference levels associated with seats in the current site, determine information of seat(s) to be recommended from among vacant seats that are currently remained according to the preference levels associated with the seats, and return the information of the seat(s) to be recommended; and providing seat recommendation based on the returned information of the seat(s) to be recommended.

In implementations, a method for providing seat information may include receiving a request for booking a seat in a current site at a client terminal; querying a preset seat information database to determine preference level information of seats in the current site, the seat information database storing respective preference level information of seats in target sites; determining information of seat(s) to be recommended from among currently remaining vacant seats according to the preference level information of the seats; and returning the information of the seat(s) to be recommended.

In implementations, a method for creating a seat information database may include collecting preferentially selected seat information in a target site according to historical seat selection records in the target site; determining preference level information of seats in the target site according to the preferentially selected seat information; and storing seat information of the seats in the target site and the preference level information corresponding to the seats as entries in a seat information database.

In implementations, an apparatus for providing seat information, which is applicable in a server, may include a seat booking request receiving unit configured to receive a request uploaded by a client terminal for booking a seat in a current site; a database query unit configured to query a preset seat information database to determine preference level information of seats in the current site, the seat information database storing respective preference level information of seats in target sites; a recommended seat determination unit configured to determine information of seat(s) to be recommended from among remaining vacant seats of the current site according to the preference level information of the seats; and a seat information returning unit configured to return the information of the seat(s) to be recommended to the client terminal.

In implementations, an apparatus for providing seat information, which is applicable in a client terminal, may include a seat booking request sending unit configured to send a request for booking a seat in a current site to a server, to cause the server to query a preset seat information database for determining information of preference levels associated with seats in the current site, determine information of seat(s) to be recommended from among currently remaining vacant seats based on the preference levels associated with the seats, and return the information of the seat(s) to be recommended; and a seat recommendation unit configured to provide seat recommendation according to the returned information of the seat(s) to be recommended.

In implementations, an apparatus for providing seat information, which is applicable in a client terminal, may include a booking request receiving unit configured to receive a request for booking a seat in a current site; a preference level query unit configured to query a preset seat information database to determine preference level information of seats in the current site, the seat information database storing respective preference level information of seats in target sites; a preferential information determination unit configured to determine information of seat(s) to be recommended from among currently remaining vacant seats according to the preference level information of the seats; and a preferential information returning unit configured to return the information of the seat(s) to be recommended.

In implementations, an apparatus for establishing a seat information database may include a preferential information collection unit configured to collect preferentially selected seat information in a target site according to historical seat selection records in the target site; a preference level determination unit configured to determine preference level information of seats in the target site according to the preferentially selected seat information; and a data storage unit configured to store seat information of the seats in the target site and the preference level information corresponding to the seats as entries in a seat information database.

According to the embodiments provided in the present disclosure, the present disclosure discloses the following technical effects:

A server may query a preset seat information database upon receiving a request for booking a seat in a current site, determine information of seat(s) to be recommended from among remaining vacant seats in the current site based on preference level information of seats of the current site that is stored in the seat information database, and return the information of the seat(s) to be recommended to a client terminal. Therefore, when a user books a seat in a target site via a client terminal, an optimal seat can be provided to the user quickly and accurately from among remaining vacant seats, thus preventing the user from missing the optimal seat by making a selection based only on experience and subjective judgment. Furthermore, seat information in the target site is provided to the user in a more efficient way, thereby saving an operation time of the user to select a seat and improving the efficiency of seat reservation.

Apparently, any product implementing the present disclosure does not need to achieve all the above advantages at the same time.

### BRIEF DESCRIPTION OF THE DRAWINGS

In order to describe the technical solutions in the embodiments of the present disclosure more clearly, accompanying drawings to be used in the embodiments are briefly described herein. Apparently, the drawings in the following description represent merely some embodiments of the present disclosure. One of ordinary skill in the art can further derive other drawings based on these drawings without making any creative effort.

FIG. 1 is a flowchart of a method for establishing a seat information database according to a first embodiment of the present disclosure.

FIG. 2 is a flowchart of a method for providing seat information according to a second embodiment of the present disclosure.

FIG. 3 is a flowchart of another method for providing seat information according to a third embodiment of the present disclosure.

FIG. 4 is a flowchart of still another method for providing seat information according to a fourth embodiment of the present disclosure.

FIG. 5 is a schematic diagram of a first apparatus according to an embodiment of the present disclosure.

FIG. 6 is a schematic diagram of a second apparatus according to an embodiment of the present disclosure.

FIG. 7 is a schematic diagram of a third apparatus according to an embodiment of the present disclosure.

FIG. 8 is a schematic diagram of a fourth apparatus according to an embodiment of the present disclosure.

FIG. 9 is a schematic diagram of the apparatus as described in FIGS. 5-8 in more detail.

### DETAILED DESCRIPTION

The technical solutions in the embodiments of the present disclosure will be described hereinafter in a clear and comprehensive manner with reference to the accompanying drawings in the embodiments of the present disclosure. Apparently, the described embodiments represent merely a part and not all of the embodiments associated with the present disclosure. All other embodiments obtained by one of ordinary skill in the art based on the embodiments in the present disclosure shall fall in the scope of protection of the present disclosure.

In real life, a user may book a movie ticket, a ticket of a show or a game, etc., through an application installed in a terminal device, and may further select a seat through a client terminal application during ticket booking. However, optimal seats are usually located at different positions in different sites. For example, different cinema halls often have different optimal viewing seats due to different seating capacities, seat arrangements, etc. Furthermore, positions of different vacant seats in a same site have different advantages and disadvantages. Due to a lack of on-site experience, a user cannot judge and select an optimal viewing seat through an interface of the application. In order to efficiently and accurately provide optimal viewing seats in different sites for the user, a method for establishing a seat information database is provided in accordance with a first embodiment of the present disclosure. The method can precisely determine optimal seats in different sites and preference levels of positions of respective seats in a venue by acquiring and making statistics on a large amount of seat selection data of users, and store such information in a seat information database in a form of computer data. As such, when a user sends a request for booking a seat in a target site through a client terminal application, optimal seat information in the target site is determined by querying the seat information database, so that an optimal seat of the remaining vacant seats in the target site can be accurately provided to the user, thus improving the efficiency of providing seat information to the user. Various embodiments of the present disclosure are described in detail hereinafter.

### First Embodiment

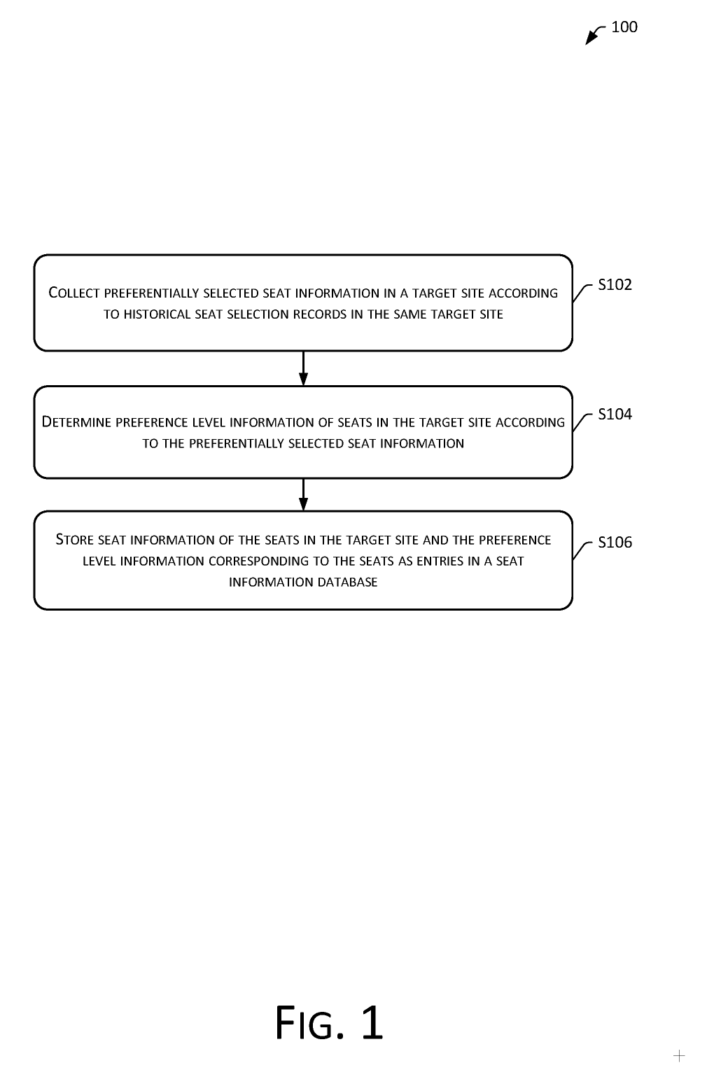

The first embodiment of the present disclosure provides a method for establishing a seat information database. FIG. 1 shows a flowchart of a method 100 for establishing a seat information database according to the first embodiment of the present disclosure. In implementations, the method 100 may include the following procedure.

S102 collects preferentially selected seat information in a target site according to historical seat selection records in the same target site.

To ensure that data in a seat information database can accurately and objectively reflect preference level information of seats in each site, a certain amount of data may be acquired, and statistics may be computed on the data. A distribution of seat selection of users is obtained by computing statistics based on the acquired data, and preference level information of seats in a target site is further determined based on user behaviors. For example, historical seat selection records in a target site may be acquired, and information of seats that are preferentially selected in the same target site is collected. When users select seats in the target site, a user who makes a selection first according to a sequential order of selections is more likely to select a seat at a better position. Therefore statistics may be computed on the information of the seats that are preferentially selected in the historical seat selection records. The information of the seats may be computer data expressions corresponding to the seats. For example, a seat may be represented in a form of a binary array, with respective data in the binary array representing a row and a column of the seat. In addition, information of a seat may be represented using a unique serial number ID. For example, a seat in a particular cinema hall of a particular cinema may be expressed as W02001. With respect to target sites, since different sites may have identical seat distributions (e.g., cinema halls of a same type and of a same operator generally have identical seat distributions), the target sites may be classified based on whether they have identical or similar seat arrangements. In this way, a target site may include multiple sites of a same type. When data in the database is generated or the database is queried, type information representing identical or similar seat arrangements may be used as a keyword for database entries.

Multiple ways of implementations may exist for achieving this operation. For example, acquisition of historical data may be implemented by acquiring real-time data of a server of a partner. The real-time data of the server of the partner generally is data that is generated in real time when users select seats on a site. Such data comes from on-site selection of the users, to whom experienced staffs usually provide recommendations. Therefore, the selected seats tend to be seats having better positions. In addition, records of seats in target sites selected by users through client terminals may be collected, thereby obtaining preferentially selected seat information in a same target site by computing statistics thereof. In this implementation, if a user selects a seat in a target site for the first time, the user may miss an optimal seat as being unfamiliar with the seat distribution. However, when selecting a seat in the same target site for the second time and thereafter, the user is more likely to select an optimal seat due to his/her on-site experience. Therefore, when statistics are computed on preferentially selected data in a same target site based on data of client terminals, data related to users performing seat selections in the target site for the first time is eliminated, and statistics are computed only on data related to seat selections in the target site by users at times other than the first time, to improve the data accuracy. Apparently, in a real application, data of the historical seat selection records may come from other sources, which are not limited in this embodiment of the present disclosure.

In addition, a plurality of different ways of implementations of collecting the preferentially selected seat information in a same target site may exist. For example, for seat booking information of each session in a same target site, only information of a seat that is first booked is collected. This is because a seat that is first booked seat in a target site is more likely to be a seat that has an optimal position in the target site. Moreover, for seat booking of sessions in a same target site, only information about first N booked seats may be collected, with N being a preset number, such as five. It is because the first batch of (such as first five) booked seats in a target site are more likely to be a batch of seats at optimal positions in the target site. In a real application, collecting the preferentially selected seat information in the same target site may also be implemented in other manners, which are not limited in this embodiment of the present disclosure. It should be noted that preference level information of seats that are to be determined based on preferentially selected seat information would be more accurate as more preferentially selected seat information in the same target site is collected. Therefore, the preferentially selected seat information in the same target site may separately be collected multiple times in multiple sessions, so that more accurate preference level information of the seats is obtained.

S104 determines preference level information of seats in the target site according to the preferentially selected seat information.

After the preferentially selected seat information in the same target site is collected, preference level information of the seats in the target site may be determined based on the preferentially selected seat information in the target site. In one implementation, higher-preference level information may be uniformly determined for preferentially selected seats in the target site, and lower-preference level information may be uniformly determined for seats that are not preferentially selected. In order divide the preference level information of the seats in the target site in a more precise manner, another implementation may also be adopted. First, the optimal seat in the target site is determined based on the preferentially selected seat information, and preference levels of other seats are determined based on a relationship of relative positions between the optimal seat and the other seats. During implementation, the optimal seat in the target site may be determined in different manners according to different ways of collection of the preferentially selected seat information.

For example, for seat booking information of each session in the same target site, only information about the first booked seat is collected. In this case, information about respective first booked seats in multiple sessions may be collected, and then the optimal seat in the target site is determined according to a distribution of respective collected numbers of times of the booked seats. In general, a number of times that each seat is preferentially selected may be determined, and the distribution of the numbers of times the booked seats is represented by the corresponding number of times that the seats are selected. A seat that is preferentially selected for the maximum number of times is determined as the optimal seat of the target site. When information about a preset number of first-batch booked seats is collected, the optimal seat in the target site may also be determined according to a distribution of a respective collected number of times that each seat is booked. For example, the number of times that each seat is preferentially selected may be determined, and a seat that is preferentially selected for the maximum number of times is determined as the optimal seat of the target site.

Furthermore, seats are arranged in a particular order in most sites, for example, arranged in specific rows and columns. The distribution of the seats is relatively regular in most cases, and a position of each seat may be uniquely determined according to a row number and a column number. A column in which the optimal seat is located is generally on the central axis of the site, i.e., a middle column among all seats, or directly faces the center of a watched object (such as a screen or a stage) in the site. Therefore, when the optimal seat in the target site is determined according to the preferentially selected seat information, row information of preferentially selected seats may be collected according to historical records of seat selection in the target site, thereby determining preferentially selected rows in the target site. Rows in which the preferentially selected seats are located are determined as preferentially selected rows, and a respective number of times that each preferentially selected row appears is counted. A row with the number of times of appearance being the maximum is determined as a target row. Furthermore, a target column may be determined according to a central position of a watched subject in the target site, and the optimal seat in the target site is determined according to the target row and the target column. In this way, the effect of inaccurate column numbers on determination of final data is avoided, thus further improving the accuracy of determining the optimal seat in the target site.

When the preferentially selected seat information in the same target site is collected, a seat that is not the most preferable may be selected for some reasons. Although being allowed to select preferred seats in a target site, some users may, for example, want to go in and out of the site at any time without interrupting other users, and therefore select positions in relatively front rows or close to the door. Such preferentially selected seats are usually not the optimal seats in the target site. Therefore, when the preference level information of the seats is determined according to the preferentially selected seat information, such data needs to be eliminated to acquire preferentially selected seat information with a higher precision, thereby determining the preference level information of the seats in the target site in a better manner. In implementations, a probability distribution of the preferentially selected seat information may be determined first. After the probability distribution is determined, data corresponding to small probabilities may be eliminated, and then the preference level information of the seats in the target site is determined according to the preferentially selected seat information after the data corresponding to small probabilities has been eliminated. In this way, preferentially selected seat information with a higher precision can be further acquired, and thereby the preference level information of the seats in the target site can be determined in more accurate manner.

It should be noted that more than one optimal seat may exist in some sites. For example, the number of columns is an even number in a certain cinema hall, and two optimal seats at the central position in the optimal row may exist. For another example, seats of some sports venues are distributed elliptically. In such venues, two or more optimal seats may exist. Nevertheless, no matter how many number of optimal seats exist in a target site, the optimal seats can be manifested based on preferentially selected seat information in the target site. In a real application, the number of optimal seats in the target site may be determined with reference to a distribution type of seats in the target site, and multiple optimal seats in the target site are determined according to preferentially selected seat information. Preference level information of other seats is further determined according to relative positions of these other seats with respect to the optimal seats.

When the preference level information of the seats is stored as computer data, positional scores of the seats may be determined according to the preference level information of the seats. For example, a positional score of 100 may be determined for the optimal seat in the target site. Relative to the optimal seat in the target site, positional scores from high to low are determined respectively for other seats according to an ascending order of distances between these other seats and the optimal seat. It should be noted that a process of determining positional scores of seats according to ascending order of distances between the seats and an optimal seat may be performed in a manner that rows take preference level over columns. For example, if a score of an optimal seat is 100, a positional score of a same-row seat adjacent to the optimal seat is determined as 98, and a positional score of a same-column seat adjacent to the optimal seat is determined as 96. Given a same-row seat and a same-column seat that are adjacent to a same seat, most users tend to preferentially select a seat that is adjacent to that particular seat in the row dimension, and select a seat that is adjacent to that particular seat in the column dimension as a second choice. Therefore, a higher preference level is determined for a same-row adjacent seat, to obtain seat preference level data that is more in line with user habits.

S106 stores seat information of the seats in the target site and the preference level information corresponding to the seats as entries in a seat information database.

After the preference level information corresponding to the seats is determined, seat information of the seats in the target site and the preference level information corresponding to the seats may be stored as entries of a seat information database. As described above, the seat information and the preference level information of the seats may be separately described using computer data of a particular form. A typical entry of a seat information database is expressed as follows:

W02001-94

In the foregoing example, seat information in an entry of the seat information database is identified using a unique serial number ID of a seat, and corresponding positional preference level information is identified using a positional score of the seat. As described above, a target site may include multiple sites having identical or similar seat distributions. Therefore, seat information (such as a serial number ID of a seat) in an entry of the seat information database may identify seats at a same position in sites of a same type. As shown in the foregoing example, when the preference level information of the seats in the target site is identified in the form of positional scores, the seat information of the seats in the target site and the positional scores corresponding to the seats may be stored as the entries in the seat information database.

The method for establishing a seat information database according to the first embodiment of the present disclosure is described in detail above. Using this method, preferentially selected seat information in a target site may be collected according to historical selection records of seats in the target site, and preference level information of the seats in the target site may be determined based on the preferentially selected seat information. Seat information and the preference level information corresponding thereto are stored as entries in a seat information database, so that the preference level information of the seats in the target site is determined according to seat selection behaviors of users. Moreover, regardless of how a seat distribution of a target site and a number of optimal seats therein are, an optimal seat in the site can be determined by computing statistics on data about seats preferentially selected by users, and thereby preference level information of other seats may be determined according to a relationship of relative positions between the other seats and the optimal seat. The preference level information of the seats obtained by this method comes from data about the seat selection behaviors of the users, and therefore more objectively reflects preference levels of seat positions. The preference level information of the seats so determined is also more accurate.

### Second Embodiment

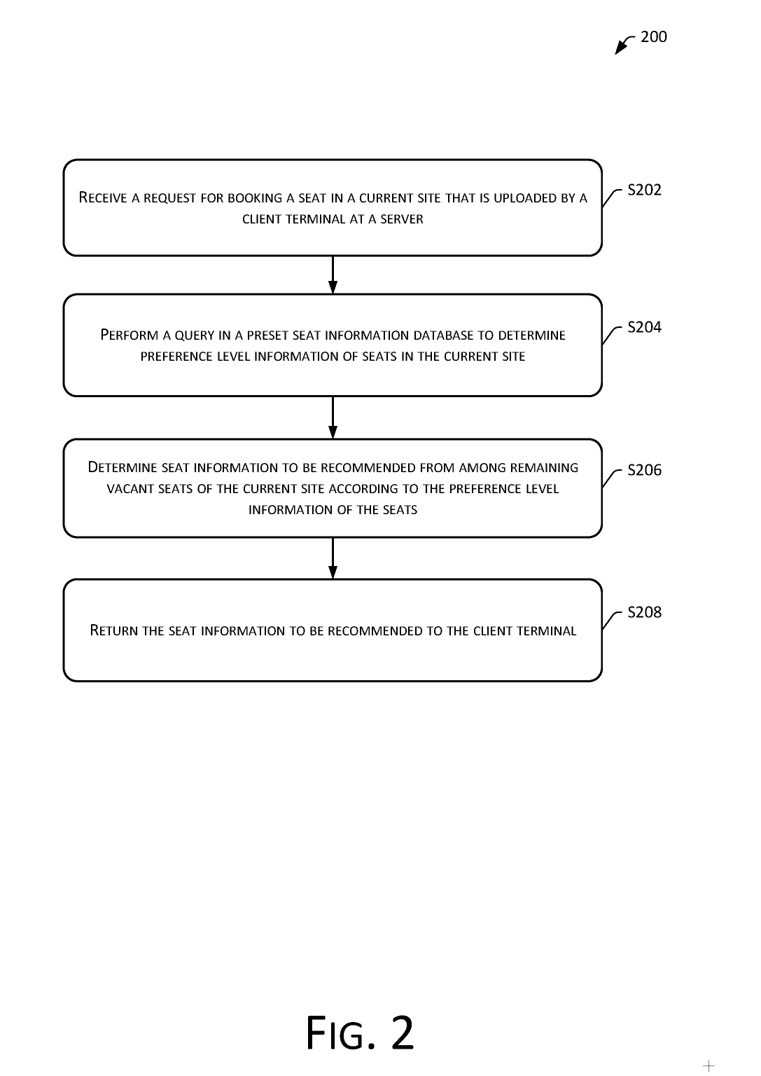

The second embodiment of the present disclosure provides a method 200 for providing seat information, which can accurately and actively provide an optimal seat in remaining vacant seats of a target site by querying a seat information database, when a user selects and books a seat in the target site, thus reducing an operation time of the user to select a seat and improving the efficiency of seat booking of the user. As shown in FIG. 2, the method 200 for providing seat information includes the following procedure.

S202 receives a request for booking a seat in a current site that is uploaded by a client terminal at a server.

When booking a seat through an application installed in a terminal device, a user may upload a request for booking a seat in a current target site via a client terminal. A server may receive the request for booking a seat in the current site that is uploaded by the client terminal via a network. Information of the seat booking request may include identifier information of the current site, such as a type number of the current site, to enable the server to determine the current site or a site type based on the identifier information, and perform a query in a database. The seat booking request may further include other information, for example, a number of booked seats, a site identifier of the booked seat, verification information or identifier information of the user, etc., to enable the server to complete user authentication, collection and registration of booking information, and other tasks, based on these pieces of information.

S204 performs a query in a preset seat information database to determine preference level information of seats in the current site, the seat information database storing respective preference level information of seats in target sites.

After receiving the request for booking a seat in the current site, the server terminal may query the preset seat information database, to determine preference level information of seats in the current site. The seat information database may be set up in the server in advance, and information stored in the seat information database mainly includes preference level information of seats in each target site. A method of generating thereof may be referenced to the method for establishing a seat information database in the first embodiment of the present disclosure, and details are not repeatedly described herein. In implementations, each piece of seat information in the seat information database may include a field for identifying whether a respective seat is vacant (or whether having been booked), and a numerical value for the field may be a Boolean numerical value to identify a vacant state (or a state of whether being booked) of the corresponding seat. The value may change according to real-time data of seat booking to record the vacant state (or booked state) of the respective seat in each target site. When the preset seat information database is queried, information of seats in the vacant state in the current site may be determined first, and preference level information of the seats in the vacant state is determined. The preference level information of the seats in the current site may be represented in a particular data form, for example, different preference level information is identified by different positional scores to facilitate subsequent preferential selection of seats, thus providing recommendation of one or more pieces of optimal seat information to the client terminal of the user.

In order to improve the query efficiency, preference level information of seats in sites of a same type may be stored in the seat information database. The sites of the same type may include multiple sites having identical seat distributions. Preference level information of seats in target site information that is stored in the seat information database includes preference level information of seats in sites of a same type. In this way, when the preset seat information database is queried to determine the preference level information of the seats in the current site, a target type to which the current site belongs may be determined first. The preset seat information database may then be queried according to the target type, and preference level information of seats in a site of the target type is determined as the preference level information of the corresponding seats in the current site.

S206 determines seat information to be recommended from among remaining vacant seats of the current site according to the preference level information of the seats.

After the preference level information of the seats in the current site is determined, seat information to be recommended may be determined from currently remaining vacant seats according to the preference level information of the seats, and the seat information may be respective position information (such as row and column numbers) of seat(s) in the current site or respective serial number(s) of the seat(s) in the current site. Generally, a seat at a better position corresponds to higher preference level information in the seat information database. Therefore, in response to the current request, one or more vacant seats having relatively high preference level information may be determined according to the preference level information of the seats, and information of the determined one or more vacant seats is determined as seat information to be recommended.

When the user books one or more seats through the client terminal, the client terminal may add information about a number of reservations into the booking request that is uploaded thereby. After receiving the booking request from the client terminal, the server may parse the booking request to determine the number of reservations associated with seat booking from the booking request. As such, when the seat information to be recommended is determined from among the currently remaining vacant seats based on the preference level information of the seats, the seat information to be recommended may be determined from the currently remaining vacant seats according to the preference level information of the seats and the number of reservations associated with seat booking, thus satisfying booking demands of different numbers of reservations in a better manner. A detailed description thereof is provided using an example hereinafter.

When the number of reservations is one, seat information having highest preference level information may be determined from the currently remaining seats to serve as the seat information to be recommended. When the number of reservations is two, the user generally hopes that the two booked seats are adjacent seats in a row. In this case, seat information having highest preference level information may be determined from the currently remaining seats first, and a determination is made as to whether an adjacent seat of a same row is vacant. If the adjacent seat of the same row is not vacant, another piece of seat information having a preference level immediately lower than that of the highest-preference level seat is determined from the currently remaining seats, and a determination is made as to whether an adjacent seat of a same row is vacant, and so forth, until seat information of two vacant seats that are adjacent in a same row is determined. The determined seat information of the two vacant seats is set as the seat information to be recommended.

When the number of booked seats is more than two (e.g., when the number of reservations is three), first, information of three vacant seats that are adjacent to each other in a row may be determined as the seat information to be recommended by using a method similar to the method used when the number of booked seats is two. In this case, three adjacent seats having relatively low preference levels may be determined. Under this situation, a preference level threshold may therefore be set up in advance first. If the three adjacent seats in a same row that are determined all have preference level information higher than the preference level threshold, the seat information thereof is determined as the seat information to be recommended. If seat information with lower than the threshold exists, corresponding implementations for the number of reservations being one and two may be separately referenced. Information of one seat and two seats is separately determined from the currently remaining vacant seats to serve as the seat information to be recommended. When the number of booked seats is four, five, or more, the seat information to be recommended may also be determined using a method similar to the method used when the number of reservations is three, and details thereof are not repeatedly described herein. In short, when the number of reservations is two or more, the seat information to be recommended is determined from the currently remaining vacant seats according to preference levels of the seats, a positional relationship between the seats, and the number of reservations. Seats corresponding to the determined seat information to be recommended can be adjacent in a same row in an event that a condition of being higher than a particular preference level threshold is satisfied. Alternatively, when this condition cannot be met, an attempt to set seat information of optimal positions as the seat information to be recommended may be made as far as possible, to fulfill the seat selection requirement of a user.

S208 returns the seat information to be recommended to the client terminal.

After the seat information to be recommended is determined from the remaining vacant seats in the current site, the seat information to be recommended may be returned to the client terminal, to enable the client terminal to call the seat information to be recommended. For example, an optimal seat in the remaining vacant seats may be recommended to the user in a client terminal application according to the seat information to be recommended, to help the user to select the optimal seat in the remaining vacant seats when the user books a seat in the target site in a more convenient manner. In addition, when the seat information to be recommended is returned to the client terminal, other data about seat(s) to be recommended may be returned. For example, when the preference level information of the seats in the seat information database is stored in a form of positional scores of the seats, positional score(s) of the seat(s) to be recommended may be returned to the client terminal when the seat information to be recommended is returned to provide reference for the user in seat selection. For another example, a perspective view of seats may be stored in a server terminal in advance. When the seat information to be recommended is returned, the perspective view of the seats to be recommended is returned to the client terminal, so that the user can know positions of the recommended seats in a more intuitive way, for example.

The method for providing seat information in accordance with the second embodiment of the present disclosure is described in detail above. By using the method, after receiving a request for booking a seat in a current site, a server performs a query on a preset seat information database, determines seat information to be recommended from remaining vacant seats in the current site based on preference level information of seats in the current site that is stored in the seat information database, and returns the seat information to be recommended to a client terminal, to enable the client terminal to provide an optimal seat in remaining vacant seats to a user in a quick and accurate manner when the user books a seat in a target site, thus avoiding the user to only rely on experience and subjective judgment and therefore miss the optimal seat. Further, an operation time of seat selection is reduced for the user, and the efficiency of booking a seat through the client terminal is improved.

### Third Embodiment

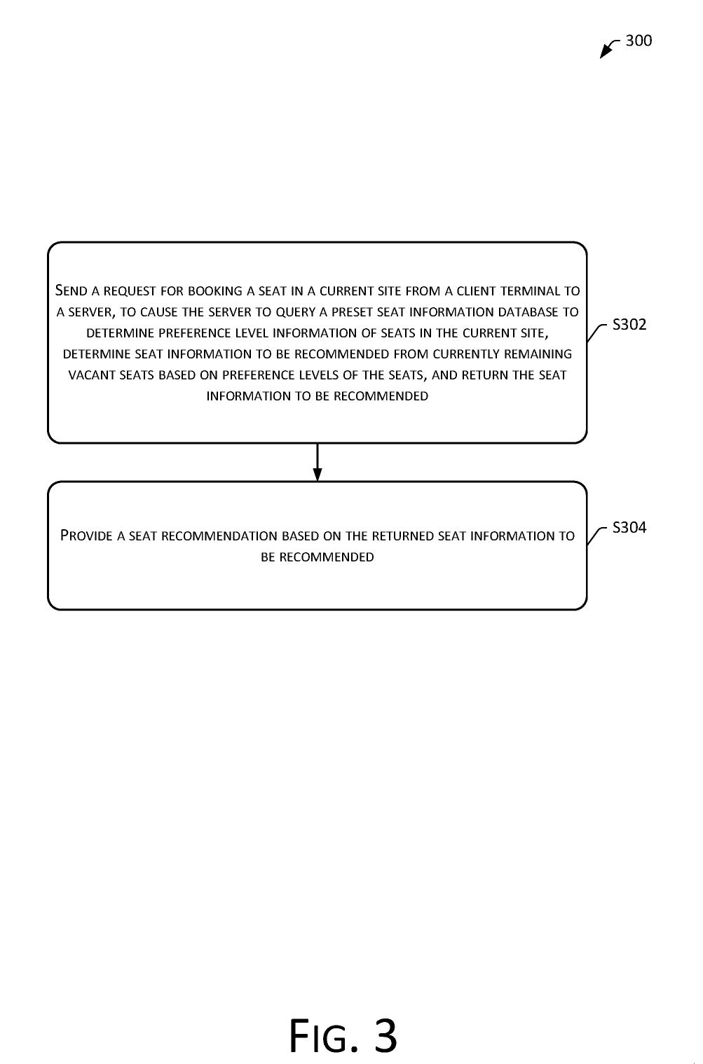

The third embodiment of the present disclosure provides a method 300 for providing seat information from the perspective of a client terminal, which provides information of an optimal seat among remaining vacant seats in a current site to a user by using a seat information database that is set up in advance in a server terminal. Referring to FIG. 3, the method 300 may include the following procedure.

S302 sends a request for booking a seat in a current site from a client terminal to a server, to cause the server to query a preset seat information database to determine preference level information of seats in the current site, determine seat information to be recommended from currently remaining vacant seats based on preference levels of the seats, and return the seat information to be recommended.

When a user books a seat in a current site through a client terminal, the client terminal may send a request for booking a seat in the current site to a server. The server may receive the request uploaded by the client terminal for booking a seat in the current site through a network, query a preset seat information database to determine preference level information of seats in the current site, select seat information to be recommended from currently remaining vacant seats according to preference levels of the seats, and return the determined seat information to be recommended.

S304 provides a seat recommendation based on the returned seat information to be recommended.

After receiving the seat information to be recommended from the server, the client terminal may recommend seats according to the seat information to be recommended. In addition, if the user is not satisfied with the recommended information, or the recommended information cannot meet an actual demand of the user, the user may perform a manual selection. After the recommendation information is provided, a seat may be booked according to a result of a manual selection if a request for the manual selection of a seat is received. Furthermore, the result of the manual selection of the user may further be uploaded to the server, to allow the server to modify data in the seat information database according to the result of the manual selection, thus further enhancing the accuracy of the data in the seat information database.

In the method provided in this embodiment of the present disclosure, preference level information of seats in a current site is stored in a seat information database that is configured in advance in a server, and data thereof comes from statistics on data of seat selection behaviors of users, which can objectively and accurately reflect preference levels of positions of the seats. When a user books a seat in the current site through a client terminal, a booking request may be sent to the server according to an actual demand of the user. After querying the seat information database, the server may quickly and accurately provide an optimal seat in remaining vacant seats to the client terminal. The client terminal automatically recommends the optimal seat in the current site to the user according to seat information to be recommended that is returned by the server, thus preventing the user from missing the optimal seat because of his/her sole reliance on experience and subjective judgment. Furthermore, an operation time of seat selection is reduced for the user, and the efficiency of booking a seat through the client terminal is improved.

### Fourth Embodiment

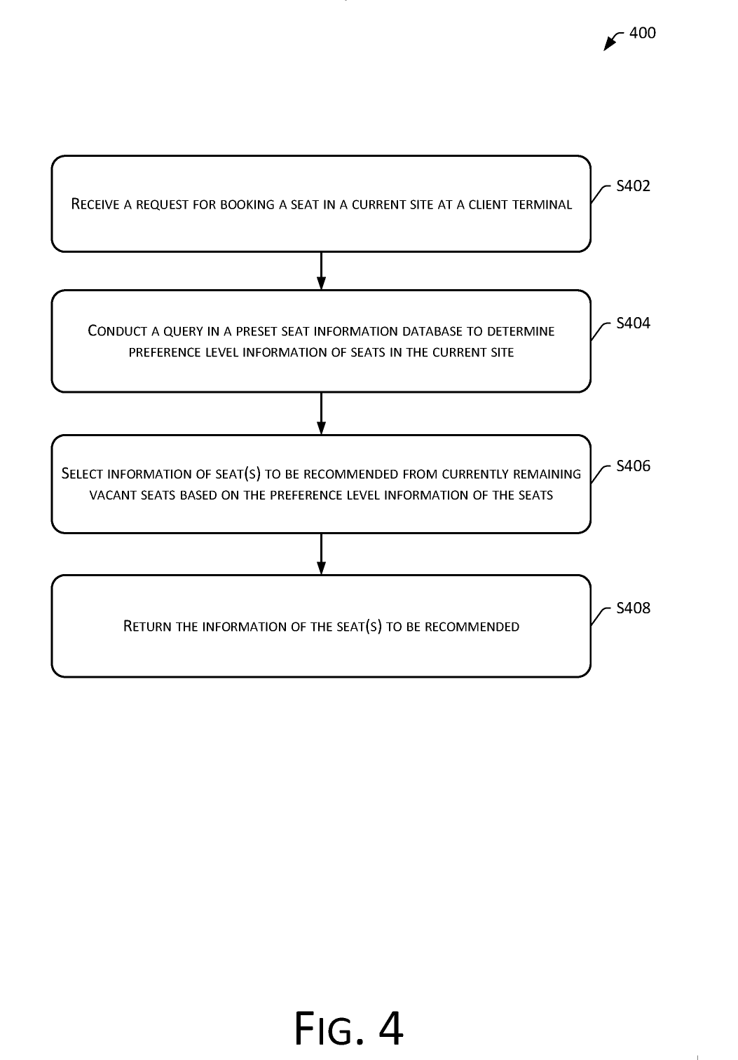

As intelligent terminal devices and network applications become more popular nowadays, data in a seat information database may also be stored in a client terminal. For example, when a user initiates a client terminal application to book a seat, real-time seat information data may be downloaded locally through a network. In this way, when implementing a provision of seat information, a method 400 for providing seat information according to the fourth embodiment of the present disclosure may be employed. As shown in FIG. 4, the method 400 may include the following procedure.

S402 receives a request for booking a seat in a current site at a client terminal.

When a user books a seat in a current site through a client terminal, the client terminal may receive a request for booking a seat in the current site.

S404 conducts a query in a preset seat information database to determine preference level information of seats in the current site, the seat information database storing preference level information of seats in target sites.

After the request for booking a seat in the current site is received, a local seat information database of the client terminal may be queried to determine preference level information of seats in the current site. Preference level information of seats in target sites is stored in the local seat information database of the client terminal.

S406 selects information of seat(s) to be recommended from currently remaining vacant seats based on the preference level information of the seats.

After the preference level information of the seats in the current site is determined, information of seat(s) to be recommended may be determined from currently remaining vacant seats based on the preference level information of the seats, and the information of the seat(s) may be respective position information (such as row and column numbers) of the seat(s) in the current site or respective serial number(s) of the seat(s) in the current site. Generally, a seat at a better position corresponds to higher preference level information in the seat information database. Therefore, in response to the current request, one or more vacant seats having relatively high preference level information may be determined according to the preference level information of the seats, and information of the one or more vacant seats that are determined is set as the information of the seat(s) to be recommended. Furthermore, when one or more seats are booked by the user through the client terminal, the information of the seat(s) to be recommended may also be determined from the currently remaining vacant seats based on the preference level information of the seats and a number of reservations associated with seat booking, to fulfill booking demands of different number of reservations in a better manner. A specific example may be referenced to the content at S206 of the second embodiment of the present disclosure, and details thereof are not repeatedly described herein.

S408 returns the information of the seat(s) to be recommended.

After the information of the seat(s) to be recommended is determined from the remaining vacant seats in the current site, the information of the seat(s) to be recommended may be returned to the client terminal, to enable the client terminal to call the information of the seat(s) to be recommended. For example, an optimal seat in the remaining vacant seats may be recommended to the user in a client terminal application based on the information of the seat(s) to be recommended, to help the user to select the optimal seat in the remaining vacant seats in a more convenient manner when the user books a seat in the target site.

The method for providing seat information provided in the fourth embodiment of the present disclosure is described in detail above. By using the method, when a user books a seat in a current site using a client terminal, a request for booking a seat in the current site may be received through the client terminal. A local seat information database in the client terminal is queried to determine preference level information of seats in the current site. An optimal seat in remaining vacant seats is accurately determined based on the preference level information of the seats, and seat information corresponding to the optimal seat is returned as seat information to be recommended, so that the optimal seat in the current site is automatically recommended to the user. By using this method, an operation time of seat selection is reduced for the user, and the efficiency of booking a seat through the client terminal is improved.

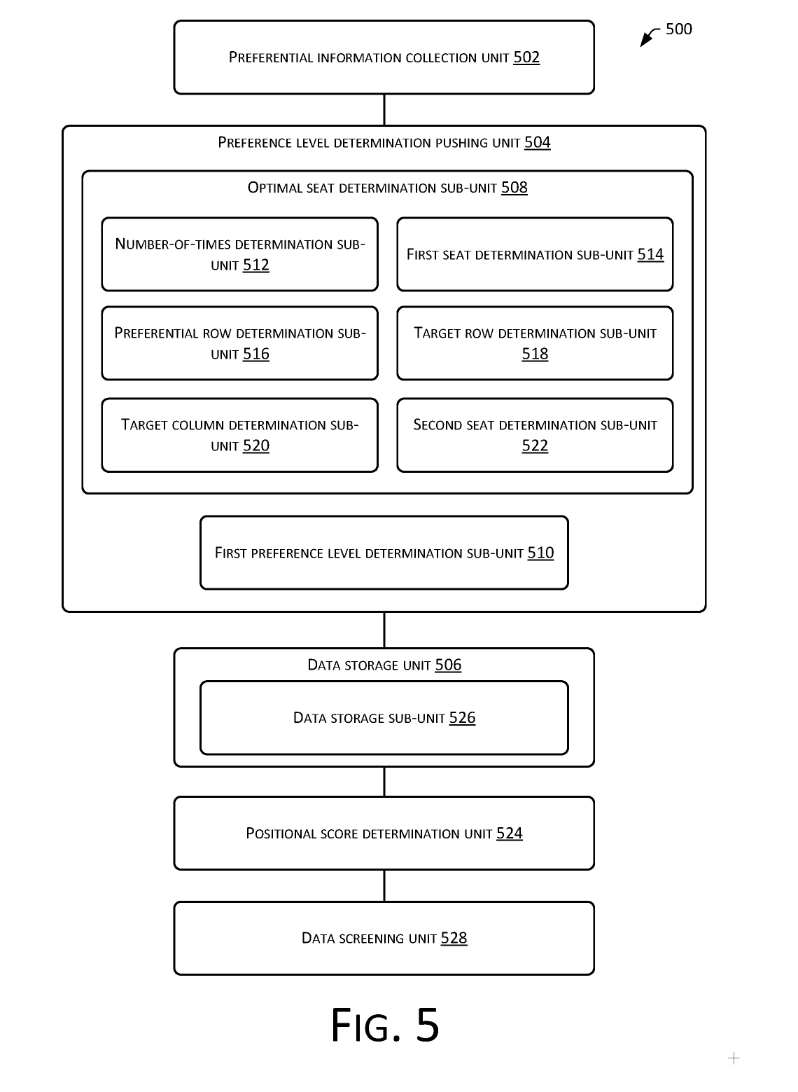

Corresponding to the method for establishing a seat information database provided in the first embodiment, an embodiment of the present disclosure further provides an apparatus 500 for establishing a seat information database. As shown in FIG. 5, the apparatus 500 may include a preferential information collection unit 502 configured to collect preferentially selected seat information in a target site based on historical seat selection records in the target site; a preference level determination unit 504 configured to determine preference level information of seats in the target site based on the preferentially selected seat information; and a data storage unit 506 configured to store seat information of the seats in the target site and the preference level information corresponding to the seats as entries in a seat information database.

The preference level determination unit 504 may include an optimal seat determination sub-unit 508 configured to determine an optimal seat in the target site according to the preferentially selected seat information; and a first preference level determination sub-unit 510 configured to determine preference level information of other seats according to a relationship associated with relative positions between the optimal seat and the other seats.

In this implementation, the optimal seat determination sub-unit 508 may include a number-of-times determination sub-unit 512 configured to determine a respective number of times that each seat is preferentially selected; and a first seat determination sub-unit 514 configured to set a seat which is preferentially selected for a number of times that is the maximum as the optimal seat of the target site.

In addition, the optimal seat determination sub-unit 508 may further may include a preferential row determination sub-unit 516 configured to determine rows in which preferentially selected seats are located as preferentially selected rows; a target row determination sub-unit 518 configured to determine a number of times that each preferentially selected row appears, and determine a row having a number of times being the maximum as a target row; a target column determination sub-unit 520 configured to determine a target column according to a central position of a watched subject in the target site; and a second seat determination sub-unit 522 configured to determine the optimal seat in the target site according to the target row and the target column.

In another implementation, the apparatus 500 may further include a positional score determination unit 524 configured to determine positional scores of the seats according to the preference level information of the seats. In this case, the data storage unit 506 may include a data storage sub-unit 526 configured to store seat information of the seats in the target site and the positional scores corresponding to the seats as the entries in the seat information database.

In addition, the apparatus 500 may further include a data screening unit 528 configured to determine a probability distribution of the preferentially selected seat information, and eliminate data having a small probability, to facilitate a determination of the preference level information of the seats in the target site based on the preferentially selected seat information from which the data having the small probability has been eliminated.

The target site may include multiple sites of a same type.

The apparatus 500 provided in this embodiment of the present disclosure is described in detail above. By using the apparatus 500, preference level information of seats in a target site may be determined based on preferentially selected seat information that is collected, and seat information and the preference level information corresponding thereto is saved as entries in a seat information database, thus achieving a determination of the preference level information of the seats in the target site according to users' activities associated with seat selection. The obtained seat preference level information comes from data about the users' activities associated with seat selection, and therefore reflects position preference levels of seat positions in a more objective manner, with the preference level information of the seats so determined being more accurate.

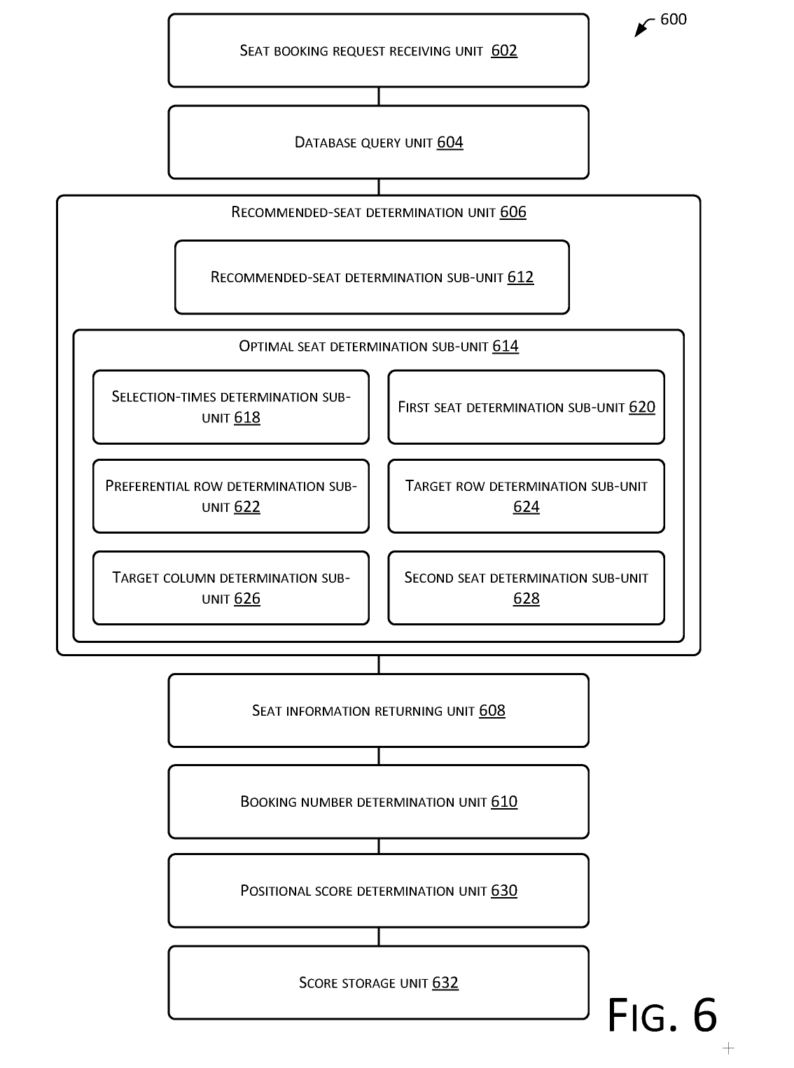

Corresponding to the method for providing seat information provided in the second embodiment of the present disclosure, an embodiment of the present disclosure further provides an apparatus 600 for providing seat information. As shown in FIG. 6, the apparatus 600 may include a seat booking request receiving unit 602 configured to receive a request for booking a seat in a current site uploaded by a client terminal; a database query unit 604 configured to query a preset seat information database to determine preference level information of seats in the current site, preference level information of seats in target sites being stored in the seat information database; a recommended-seat determination unit 606 configured to determine seat information to be recommended from remaining vacant seats of the current site according to the preference level information of the seats; and a seat information returning unit 608 configured to return the seat information to be recommended to the client terminal.

In another implementation, the apparatus 600 may further include a booking number determination unit 610 configured to determine a number of reservations associated with seat booking from the booking request.

In this case, the recommended-seat determination unit 606 may include a recommended-seat determination sub-unit 612 configured to determine the to-be-recommended seat information from the remaining vacant seats in the current site based on the preference level information of the seats and the number of reservations.

When the number of reservations is two or more, the recommended-seat determination sub-unit may determine the seat information to be recommended from the remaining vacant seats in the current site based on preference levels of the seats, a positional relationship between the seats, and the number of reservations.

The preference level information of seats in the target site that can be saved in the seat information database includes preference level information of seats in sites of a same type. In this implementation, the database query unit 604 may determine a target type to which the current site belongs, query the preset seat information database according to the target type, and set preference level information of seats in a site of the target type as the preference level information of the corresponding seats in the current site.

In addition, the preference level information of the seats saved in the seat information database may be positional scores of the seats. The apparatus may further include a seat score returning unit configured to return positional scores of seats to be recommended to the client terminal when returning the seat information to be recommended.

In implementations, the preference level information of the seats saved in the seat information database is obtained based on preferentially selected seat information in a same target site.

In implementations, the recommended-seat determination unit 606 may include additional units that are configured to obtain preference level information of the seats. For example, the recommended-seat determination unit 606 may include an optimal seat determination sub-unit 614 configured to determine an optimal seat in the target site according to the preferentially selected seat information; and a first preference level determination sub-unit 616 configured to determine preference level information of other seats based on a relationship associated with relative positions between the optimal seat and the other seats.

The optimal seat determination sub-unit 614 may include a selection-times determination sub-unit 618 configured to determine a respective number of times that each seat is preferentially selected; and a first seat determination sub-unit 620 configured to set a seat having been preferentially selected for a number of times to be the maximum as the optimal seat of the target site.

Additionally or alternatively, the optimal seat determination sub-unit 614 may include a preferential row determination sub-unit 622 configured to determine rows in which preferentially selected seats are located as preferentially selected rows; a target row determination sub-unit 624 configured to determine the number of times that each preferentially selected row appears, and determine a row which appears for a number of times being the highest as a target row; a target row determination sub-unit 626 configured to determine a target column according to a central position of a watched subject in the target site; and a second seat determination sub-unit 628 configured to determine the optimal seat in the target site based on the target row and the target column.

In addition, the apparatus 600 may further include a positional score determination unit 630 configured to determine positional scores of the seats based on the preference level information of the seats; and a score storage unit 632 configured to store respective positional scores corresponding to the seats in the target site as respective preference level information in the seat information database.

In order to make data to be more accurate, the apparatus may further include a data screening unit configured to determine a probability distribution of the preferentially selected seat information, and eliminate small-probability data, so as to determine the preference level information of the seats in the target site based on the preferentially selected seat information from which the small-probability data has been eliminated.

The target site includes multiple sites of a same type.

The apparatus for providing seat information provided in this embodiment of the present disclosure is described in detail above. By using the apparatus, after receiving a request for booking a seat in a current site, a server may query a preset seat information database, determine seat information to be recommended from remaining vacant seats in the current site according to preference level information of seats in the current site stored in the seat information database, and return the seat information to be recommended to a client terminal, so that, an optimal seat in remaining vacant seats can be provided to a user quickly and accurately when the user books a seat in a target site through the client terminal, thus avoiding the user to miss the optimal seat due to his/her sole reliance on experience and subjective judgment. Furthermore, an operation time of seat selection is reduced for the user, and the efficiency of booking a seat through the client terminal is improved.

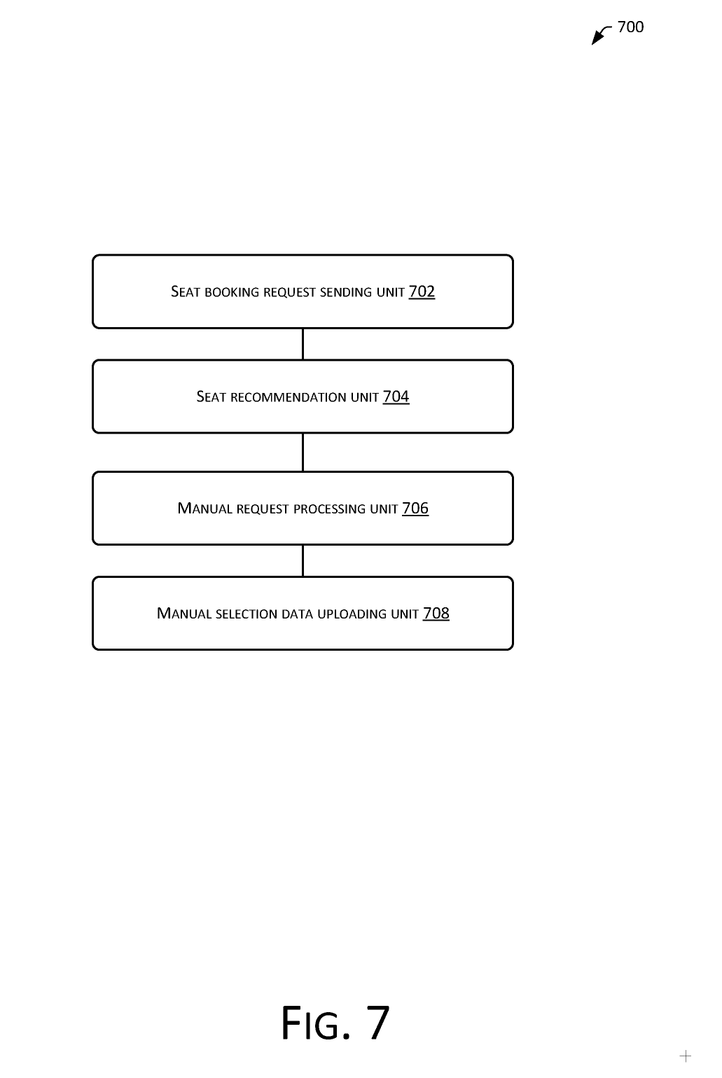

Corresponding to the method for providing seat information provided in the third embodiment of the present disclosure, an embodiment of the present disclosure further provides another apparatus 700 for providing seat information. As shown in FIG. 7, the apparatus 700 may include a seat booking request sending unit 702 configured to send a request for booking a seat in a current site to a server, to cause the server to query a preset seat information database for determining preference level information of seats in the current site, determining seat information to be recommended from currently remaining vacant seats based on preference levels of the seats, and returning the seat information to be recommended; and a seat recommendation unit 704 configured to provide seat recommendation according to the returned seat information to be recommended.

In another implementation, the apparatus 700 may further include a manual request processing unit 706 configured to book a seat according to a manual selection result, if a request for manual seat selection is received after information of the recommendation is provided.

In this implementation, the apparatus may further include a manual selection data uploading unit 708 configured to upload the manual selection result to the server, to enable the server to correct data in the seat information database according to the manual selection result.

By using the apparatus, when a user books a seat in a current site through a client terminal, a booking request may be sent to a server according to an actual demand of the user. After querying a seat information database, the server may quickly and accurately provide an optimal seat in remaining vacant seats to the client terminal. The client terminal automatically recommends the optimal seat in the current site to the user according to seat information to be recommended that is returned by the server, thus reducing an operation time of the user for selecting a seat, and improving the efficiency of booking a seat through the client terminal.

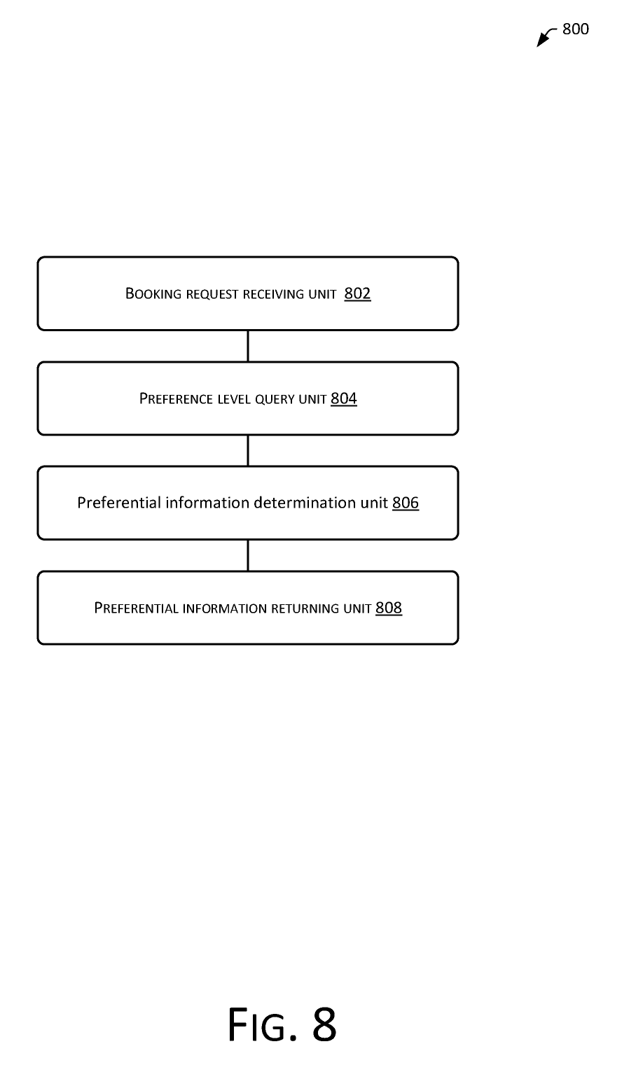

Corresponding to the method for providing seat information provided in the fourth embodiment of the present disclosure, an embodiment of the present disclosure further provides another apparatus for providing seat information. As shown in FIG. 8, the apparatus may include a booking request receiving unit 802 configured to receive a request for booking a seat in a current site; a preference level query unit 804 configured to query a preset seat information database to determine preference level information of seats in the current site, preference level information of seats in target sites being stored in the seat information database; a preferential information determination unit 806 configured to determine seat information to be recommended from currently remaining vacant seats based on the preference level information of the seats; and a preferential information returning unit 808 configured to return the seat information to be recommended.

By using the apparatus, when a user books a seat in a current site by using a client terminal, a request for booking a seat in the current site may be received through the client terminal. A local seat information database in the client terminal is queried to determine preference level information of seats in the current site. An optimal seat in remaining vacant seats is accurately determined based on the preference level information of the seats, and seat information corresponding to the optimal seat is returned as seat information to be recommended, so that the optimal seat in the current site is automatically recommended to the user. An operation time of seat selection is reduced for the user, and the efficiency of booking a seat through the client terminal is improved.

Through the description of the foregoing implementations, one skilled in the art can clearly understand that the present disclosure can be implemented by software with a necessary universal hardware platform. Based on such understanding, the essence of the technical solutions of the present disclosure, or the portion that makes contribution to the existing technologies may be embodied in a form of a software product. The software product may be stored in a storage media, such as a ROM/RAM, a magnetic disk, or an optical disc, and include instructions to cause a computing device (which may be a personal computer, a server, a network device, or the like) to execute the methods in the embodiments or in certain portions of the embodiments of the present disclosure.

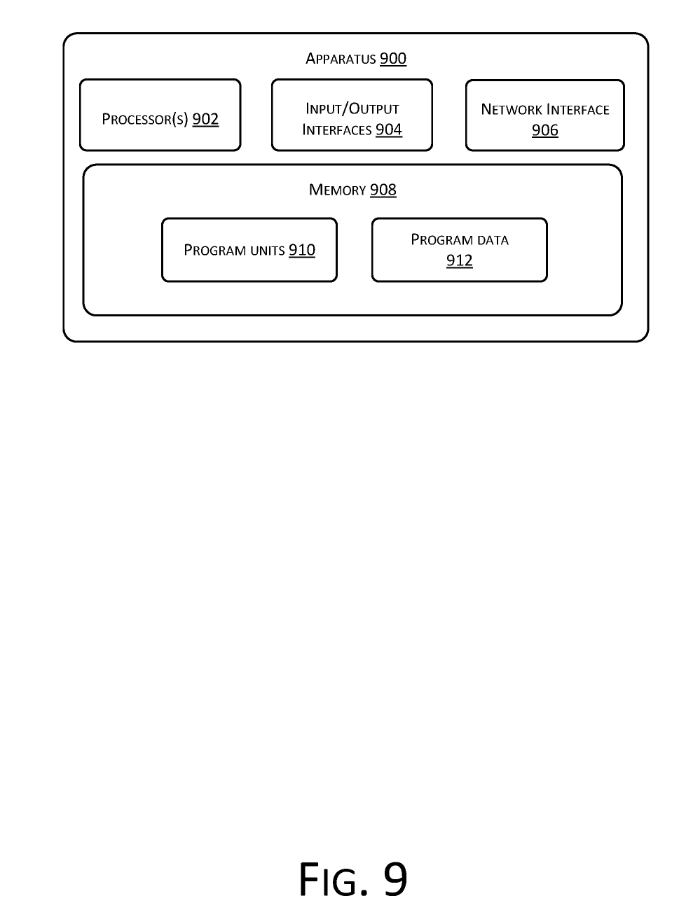

By way of example and not limitation, FIG. 9 shows an example apparatus 900, such as the apparatuses as described above, in more detail. In implementations, the apparatus 900 may include, but is not limited to, one or more processors 902, an input/output interface 904, a network interface 906, and memory 908.

The memory 908 may include a form of computer readable media such as a volatile memory, a random access memory (RAM) and/or a non-volatile memory, for example, a read-only memory (ROM) or a flash RAM. The memory 908 is an example of a computer readable media.

The computer readable media may include a volatile or non-volatile type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 908 may include program units 910 and program data 912. Depending on whether the apparatus 900 correspond to any one of the apparatuses 500-800, etc., the program units 910 may include different combinations of units and subunits. Details of these units and subunits may be found in the foregoing description and are therefore not redundantly described herein.

The embodiments in this specification are described in a progressive manner. Same or similar parts in the embodiments may be referenced to each other. Each embodiment focuses on aspects that are different from those of other embodiments. Especially, the description of the systems or system embodiments is relatively simple due to their substantially similarities to the method embodiments. Related parts may be referenced to the description of respective portions of the method embodiments. The systems or system embodiments described above are merely schematic. The units described as separate components may or may not be physically separate, and a component displayed as a unit may or may not be a physical unit, i.e., may be located at a single place, or distributed over multiple network units. Some or all of the modules may be selected according to an actual requirement, to achieve the objectives of the solutions of the embodiments. One of ordinary skill in the art can understand and implement the present disclosure without making any creative effort.

The methods and apparatuses for providing seat information according to the present disclosure are described in detail above. Specific examples are used herein to illustrate the principles and implementations of the present disclosure. The description of the above embodiments is merely used to help understand the methods of the present disclosure and the core ideas thereof. Furthermore, one of ordinary skill in the art may make modifications to exemplary implementations and the scope of application according to the ideas of the present disclosure. In conclusion, the content of the specification should not be construed as a limitation to the present disclosure.

What is claimed is:

1. A method implemented by a server, the method comprising:
receiving a seat booking request for a current site uploaded by a client terminal;
determining preference level information of seats in the current site by querying a preset seat information database;
determining seat information to be recommended from remaining vacant seats of the current site based at least in part on the preference level information of the seats; and
returning the seat information to be recommended to the client terminal.

2. The method of claim 1, further comprising determining a number of seats to be booked from the booking request, wherein determining the seat information to be recommended from the remaining vacant seats of the current site is based further on the number of seats to be booked.

3. The method of claim 2, wherein determining the seat information to be recommended from the remaining vacant seats in the current site is based further on a positional relationship between the seats when the number of seats to be booked is more than one.

4. The method of claim 1, wherein determining the preference level information of the seats in the current site comprises:
determining a target type to which the current site belongs; and
querying the preset seat information database according to the target type, and setting preference level information of seats in a site of the target type as the preference level information of the seats in the current site.

5. The method of claim 1, wherein the preference level information of the seats stored in the seat information database includes positional scores of the seats, and the method further comprises returning respective positional scores of seats to be recommended to the client terminal when returning the seat information to be recommended.

6. The method of claim 1, further comprising:
obtaining the preference level information of the seats according to preferentially selected seat information in the target site; and
storing the preference level information of the seats in the seat information database.

7. The method of claim 6, wherein obtaining the preference level information of the seats comprises:
determining an optimal seat in the target site based at least in part on the preferentially selected seat information; and
determining preference level information of other seats based at least in part on a relative positional relationship between the optimal seat and the other seats.

8. The method of claim 7, wherein determining the optimal seat in the target site based at least in part on the preferentially selected seat information comprises:
determining a respective number of times that each seat is preferentially selected; and
determining a seat having been preferentially selected for a highest number of times as the optimal seat of the target site.

9. The method of claim 7, wherein determining the optimal seat in the target site based at least in part on the preferentially selected seat information comprises:
determining rows in which preferentially selected seats are located as preferentially selected rows;
determining a respective number of times that each preferentially selected row appears, and determining a row which appears for a highest number of times as a target row;
determining a target column according to a central position of a watched subject in the target site; and
determining the optimal seat in the target site based at least in part on the target row and the target column.

10. The method of claim 6, further comprising:
determining positional scores of the seats according to the preference level information of the seats; and
storing the positional scores corresponding to the seats in the target site in the seat information database.

11. The method of claim 6, further comprising determining a probability distribution of the preferentially selected seat information, and eliminating small-probability data to determine the preference level information of the seats in the target site according to the preferentially selected seat information from which the small-probability data has been eliminated.

12. The method of claim 6, wherein the target site comprises multiple sites of a same type.

13. An apparatus implemented by a client terminal comprising one or more processors and memory, the apparatus comprising:
a seat booking request sending unit configured to send a request for booking a seat in a current site to a server, to cause the server to query a preset seat information database for determining preference level information of seats in the current site, determining seat information to be recommended from currently remaining vacant seats based on preference levels of the seats, and returning the seat information to be recommended; and
a seat recommendation unit configured to provide a seat recommendation according to the returned seat information to be recommended.

14. The apparatus of claim 13, further comprising a request processing unit configured to book a seat according to a manual selection result, if a request for manual seat selection is received after information of the recommendation is provided.

15. The apparatus of claim 13, further comprising a selection data uploading unit configured to upload the manual selection result to the server, to allow the server to correct data in the seat information database according to the manual selection result.

16. One or more computer-readable media storing executable instructions that, when executed by one or more processors of a client terminal, cause the one or more processors to perform acts comprising:
collecting preferentially selected seat information in a target site according to historical seat selection records in the target site;
determining preference level information of seats in the target site based on the preferentially selected seat information; and
storing seat information of the seats in the target site and the preference level information corresponding to the seats as entries in a seat information database.

17. The one or more computer-readable media of claim 16, wherein determining preference level information of seats in the target site comprises:
determining an optimal seat in the target site according to the preferentially selected seat information; and
determining preference level information of other seats according to relative positional relationships between the optimal seat and the other seats.

18. The one or more computer-readable media of claim 17, wherein determining the optimal seat in the target site comprises:
determining rows in which preferentially selected seats are located as preferentially selected rows;
determining a respective number of times that each preferentially selected row appears, and determine a row, which appears for a maximum number of times, as a target row;
determining a target column according to a central position of a watched subject in the target site; and
determining the optimal seat in the target site based on the target row and the target column.

19. The one or more computer-readable media of claim 16, the acts further comprising:
determining positional scores of the seats based on the preference level information of the seats; and
storing the positional scores of the seats along with the seat information of the seats in the target site and the preference level information corresponding to the seats in the seat information database.

20. The one or more computer-readable media of claim 16, further comprising:
receiving a seat booking request for the target site uploaded by a client terminal;
determining seat information to be recommended from remaining vacant seats of the target site based at least in part on the preference level information of the seats; and
returning the seat information to be recommended to the client terminal.
